(19) United States
(12) Patent Application Publication
(10) Pub. No.: US 2024/0403663 A1
(43) Pub. Date: Dec. 5, 2024

(54) RESERVING COMPUTING RESOURCES IN CLOUD COMPUTING ENVIRONMENTS

(71) Applicant: SAP SE, Walldorf (DE)

(72) Inventor: Swapnil Anil Janorkar, Singapore (SG)

(21) Appl. No.: 18/327,191

(22) Filed: Jun. 1, 2023

(51) Int. Cl. G06N 5/022; G06F 9/50

(52) U.S. Cl. CPC G06N 5/022; G06F 9/5016

(57) ABSTRACT

Methods, systems, and computer-readable storage media for providing historic compute instance (CI) training data at least partially representative of one or more compute instances executing an application in a cloud computing environment, the one or more compute instances being provided in a tenant namespace for a tenant, the tenant namespace being provided in a cluster of the cloud computing environment, training a CI predictor using the historic CI training data, receiving, from a CI adjuster, a first prediction request, transmitting, in response to the first prediction request, a first prediction generated by the CI predictor based on the first prediction request, and instantiating a first set of compute instances within the tenant namespace in response to the first prediction.

### BACKGROUND

Cloud computing can be described as Internet-based computing that provides shared computer processing resources, and data to computers and other devices on demand. Users can establish respective sessions, during which processing resources, and bandwidth are consumed. During a session, for example, a user is provided on-demand access to a shared pool of configurable computing resources (e.g., computer networks, servers, storage, applications, and services). The computing resources can be provisioned and released (e.g., scaled) to meet user demand. A common architecture in cloud platforms includes services (also referred to as microservices), which have gained popularity in service-oriented architectures (SOAs). In such SOAs, applications are composed of multiple, independent services that are deployed in standalone containers with well-defined interfaces. The services are deployed and managed within the cloud platform and run on top of a cloud infrastructure.

For example, a software vendor can provide an application that is composed of a set of services that are executed within a cloud platform. Each service is itself an application (e.g., a Java application) and one or more instances of a service can execute within the cloud platform. In some examples, multiple tenants (e.g., users, enterprises) use the same application. Consequently, each service is multi-tenant aware (i.e., manages multiple tenants) and provides resource sharing (e.g., network throughput, database sharing, hypertext transfer protocol (HTTP) restful request handling on application programming interfaces (APIs)). In multi-tenant deployments, if a tenant overloads the system, other tenants experience slower response times in their interactions with the application. This is referred to as multi-tenant interference and can result in violations of service level agreements (SLAs), such as response times that are slower than expected response times.

In modern software deployments, containerization is implemented, which can be described as operating system (OS) virtualization. In containerization, services are run in isolated user spaces referred to as containers. The containers use the same shared OS, and each provides a fully packaged and portable computing environment. That is, each container includes everything an application needs to execute (e.g., binaries, libraries, configuration files, dependencies). Because a container is abstracted away from the OS, containerized applications can execute on various types of infrastructure. For example, using containers, an application can execute in any of multiple cloud-computing environments.

Container orchestration automates the deployment, management, scaling, and networking of containers. For example, container orchestration systems, in hand with underlying containers, enable applications to be executed across different environments (e.g., cloud computing environments) without needing to redesign the application for each environment. Enterprises that need to deploy and manage a significant number of containers (e.g., hundreds or thousands of containers) leverage container orchestration systems. An example container orchestration system is the Kubernetes platform, maintained by the Cloud Native Computing Foundation, which can be described as an open-source container orchestration system for automating computer application deployment, scaling, and management. The container orchestration system can scale a number of containers, and thus resources to execute an application. For example, Kubernetes provides an autoscaling feature, which increases available resources as demand increases and decreases available resources as the demand decreases.

### SUMMARY

Implementations of the present disclosure are directed to reserving computing resources in cloud computing environments. More particularly, implementations of the present disclosure are directed to using a machine learning (ML) model to predict computing resources required within a cloud computing environment and instantiating resources based on the prediction.

In some implementations, actions include providing historic compute instance (CI) training data at least partially representative of one or more compute instances executing an application in a cloud computing environment, the one or more compute instances being provided in a tenant namespace for a tenant, the tenant namespace being provided in a cluster of the cloud computing environment, training a CI predictor using the historic CI training data, receiving, from a CI adjuster, a first prediction request, transmitting, in response to the first prediction request, a first prediction generated by the CI predictor based on the first prediction request, and instantiating a first set of compute instances within the tenant namespace in response to the first prediction. Other implementations of this aspect include corresponding systems, apparatus, and computer programs, configured to perform the actions of the methods, encoded on computer storage devices.

These and other implementations can each optionally include one or more of the following features: the first prediction defines the first set of compute instances and, for each compute instance in the first set of compute instances, assigns a type; each type corresponds to a release plan in a set of release plans, each release plan defining a number of processors and a memory size for a respective compute instance; the CI predictor is specific to the tenant and the application; the first set of compute instances is instantiated for a time period; actions further include receiving, from the CI adjuster, a second prediction request, transmitting, in response to the second prediction request, a second prediction generated by the CI predictor based on the second prediction request, and instantiating a second set of compute instances within the tenant namespace in response to the second prediction, the second set of compute instance being instantiated for a time period after the first set of compute instances; and the CI predictor is provided as a linear regression model.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example container orchestration architecture.

FIG. 3 depicts a conceptual architecture in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to reserving computing resources in cloud computing environments. More particularly, implementations of the present disclosure are directed to using a machine learning (ML) model to predict computing resources required within a cloud computing environment and instantiating resources based on the prediction. Implementations can include actions of providing historic compute instance (CI) training data at least partially representative of one or more compute instances executing an application in a cloud computing environment, the one or more compute instances being provided in a tenant namespace for a tenant, the tenant namespace being provided in a cluster of the cloud computing environment, training a CI predictor using the historic CI training data, receiving, from a CI adjuster, a first prediction request, transmitting, in response to the first prediction request, a first prediction generated by the CI predictor based on the first prediction request, and instantiating a first set of compute instances within the tenant namespace in response to the first prediction.

To provide further context for implementations of the present disclosure, and as introduced above, cloud computing can be described as Internet-based computing that provides shared computer processing resources, and data to computers and other devices on demand. Users can establish respective sessions, during which processing resources, and bandwidth are consumed. During a session, for example, a user is provided on-demand access to a shared pool of configurable computing resources (e.g., computer networks, servers, storage, applications, and services). The computing resources can be provisioned and released (e.g., scaled) to meet user demand. A common architecture in cloud platforms includes services (also referred to as microservices), which have gained popularity in service-oriented architectures (SOAs). In such SOAs, applications are composed of multiple, independent services that are deployed in standalone containers with well-defined interfaces. The services are deployed and managed within the cloud platform and run on top of a cloud infrastructure.

For example, a software vendor can provide an application that is composed of a set of services that are executed within a cloud platform. By way of non-limiting example, an electronic commerce (e-commerce) application can be composed of a set of 20-30 services, each service performing a respective function (e.g., order handling, email delivery, remarking campaigns, handling and payment). Each service is itself an application (e.g., a Java application) and one or more instances of a service can execute within the cloud platform. In some examples, such as in the context of e-commerce, multiple tenants (e.g., users, enterprises) use the same application. For example, and in the context of e-commerce, while a brand (e.g., an enterprise) has their individual web-based storefront, all brands share the same underlying services. Consequently, each service is multi-tenant aware (i.e., manages multiple tenants) and provides resource sharing (e.g., network throughput, database sharing, hypertext transfer protocol (HTTP) restful request handling on application programming interfaces (APIs)). In multi-tenant deployments, if a tenant overloads the system, other tenants experience slower response times in their interactions with the application. This is referred to as multi-tenant interference and can result in violations of service level agreements (SLAs), such as response times that are slower than expected or guaranteed response times.

In modern software deployments, containerization is implemented, which can be described as operating system (OS) virtualization. In containerization, services are run in isolated user spaces referred to as containers. The containers use the same shared OS, and each provides a fully packaged and portable computing environment. That is, each container includes everything an application needs to execute (e.g., binaries, libraries, configuration files, dependencies). Because a container is abstracted away from the OS, containerized applications can execute on various types of infrastructure. For example, using containers, an application can execute in any of multiple cloud-computing environments.

Container orchestration automates the deployment, management, scaling, and networking of containers. For example, container orchestration systems, in hand with underlying containers, enable applications to be executed across different environments (e.g., cloud computing environments) without needing to redesign the application for each environment. Enterprises that need to deploy and manage a significant number of containers (e.g., hundreds or thousands of containers) leverage container orchestration systems. An example container orchestration system is the Kubernetes platform, maintained by the Cloud Native Computing Foundation, which can be described as an open-source container orchestration system for automating computer application deployment, scaling, and management.

An attractive feature of Kubernetes is scalability, which allows the applications and infrastructures hosted to scale in and out on demand. Kubernetes manages containers within pods, which are the smallest deployable objects in Kubernetes. Each pod can contain one or more containers, and the containers in the same pod share resources of the pod (e.g., networking and storage resources). One or more hyperscalers can be used to scale compute instances (computing resources) within a cluster. Scaling can ensure that there are a sufficient number of nodes executing instances of an application to meet demand.

However, a Kubernetes cluster (e.g., a Gardner cluster) take approximately 12-15 minutes to provision a new compute instance from the hyperscaler. If there is no empty compute instance present in the cluster, the application will have to wait until a new compute instance is provisioned by the hyperscaler. Further, during traffic peak periods, applications can be scaled horizontally based on parameters such as request per minute (RPM), average computer processing unit (CPU) utilization, and the like. If there is not an available compute instance in the cluster, scaling will be delayed. This results in increased request latency and more frequent request dropping.

In an attempt to address this, some traditional approaches provide that each tenant within the cloud computing environment manually set a configuration for reserving compute instances in advance for each instance type by analyzing historic node usage patterns. The configuration contains the number of compute instance to be reserved for difference instance types (e.g., CPU, GPU). In some instances, a low priority, dummy application can be instantiated and deployed to a cluster using the reserved computer instances. During new application deployment or existing application scaling, the low priority dummy applications will be used, if a compute instance is not present in the cluster. Further, the tenant must manually adjust the reserved compute instance configuration periodically to avoid over provision or under provision of resources.

However, traditional approaches suffer from multiple technical disadvantages. For example, manually setting the configuration for reserved compute instances configuration is not scalable. That is, the tenant must invest time to analyze the compute instance usage pattern and adjust the configuration periodically to avoid over/under provision of compute instances. Over provision of compute instances will result in wasted resources (memory, processors) and under provision will result in higher inference request latencies, low availability, and increased frequency in dropped requests.

In view of the above context, implementations of the present disclosure provide are directed to using a ML model, also referred to herein as a compute instance (CI) predictor, to predict computing resources required within a cloud computing environment and instantiating resources based on the prediction. In accordance with implementations of the present disclosure, the CI predictor predicts compute instances that are to be provisioned for a time period (e.g., hour, day, week). In some implementations, the CI predictor predicts a type of instance for each of the compute instances. In some examples, the CI predictor predicts compute instances for a particular tenant among a plurality of tenants of the cloud computing environment.

Implementations of the present disclosure are described in further detail herein with reference to an example application. The example application includes an artificial intelligence (AI)-based application provided using SAP AI Core provided by SAP SE of Walldorf, Germany. SAP AI Core can be described as a service in the SAP Business Technology Platform (BTP) and is designed to handle the execution and operations of AI assets in a standardized, scalable, and hyperscaler-agnostic way. In some examples, the AI-based application includes functionality that uses one or more AI models to perform tasks (e.g., document matching). It is contemplated, however, that implementations of the present disclosure can be realized using any appropriate application executable using compute instances within a cloud computing environment.

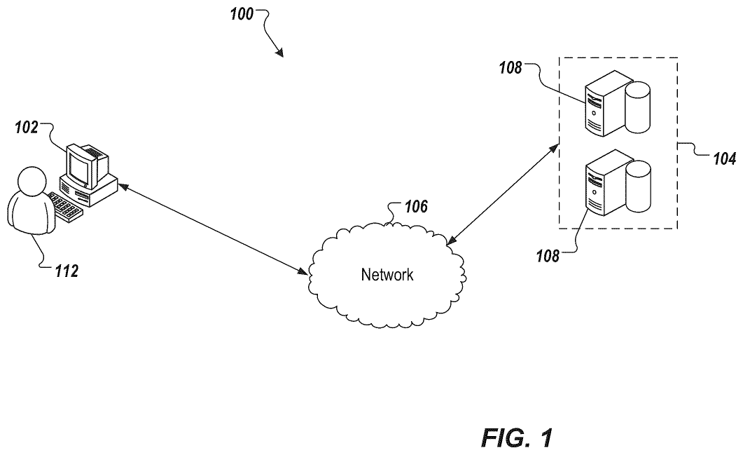

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can provide a cloud computing environment that includes multiple compute instances for executing an application. A compute instance can include technical resources (e.g., processors, memory) that execute an instance of the application. In some examples, compute instances are provided for each tenant in a set of tenants that enable each tenant to interact with the application. As described in further detail herein, a CI predictor is hosted within the cloud computing environment to predict compute instances that are to be provisioned for a time period (e.g., hour, day, week) for each tenant in the set of tenants. In some implementations, the CI predictor predicts a type of instance for each of the compute instances. As discussed in further detail herein, the number and type of compute instances are instantiated (e.g., within a cluster of a container orchestration system) for the time period.

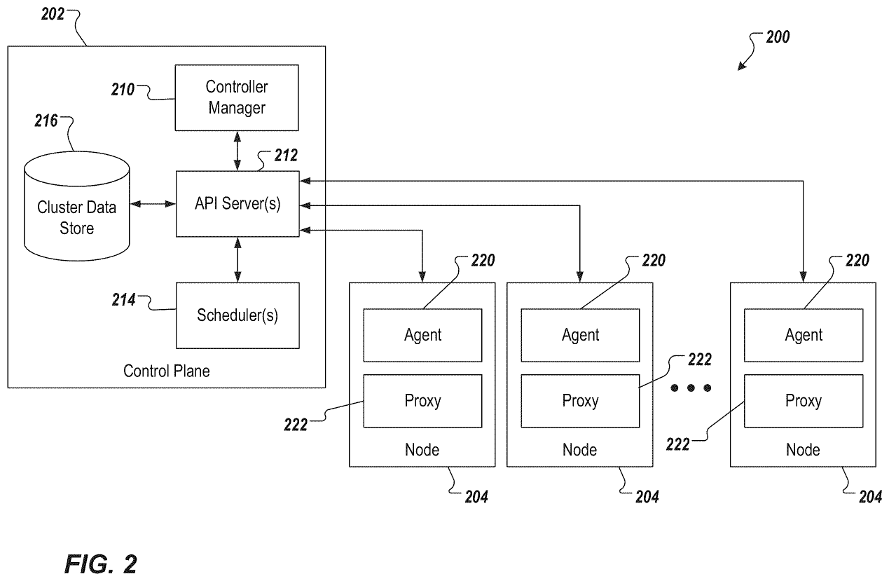

FIG. 2 depicts an example container orchestration architecture 200. In the depicted example, the example container orchestration architecture 200 represents deployment of a portion of the container orchestration system Kubernetes introduced above. More particularly, the example architecture 200 represents a basic structure of a cluster within Kubernetes

In the example of FIG. 2, the example architecture 200 includes a control plane 202 and a plurality of nodes 204. Each node 204 can represent physical worker machines and are configured to host pods. In Kubernetes, a pod is the smallest deployable unit of resources and each pod is provided as one or more containers with shared storage/network resources, and a specification for how to run the containers. In some examples, a pod can be referred to as a resource unit that includes an application container. The control plane 202 communicates with the nodes 204 and is configured to manage all of the nodes 204 and the pods therein.

In further detail, the control plane 202 is configured to execute global decisions regarding the cluster as well as detecting and responding to cluster events. In the example of FIG. 2, the control plane 202 includes a control manager 210, one or more application programming interface (API) server(s) 212, one or more scheduler(s) 214, and a cluster data store 216. The API server(s) 212 communicate with the nodes 204 and exposes the API of Kubernetes to exchange information between the nodes 204 and the components in the control plane 202 (e.g., the cluster data store 216). In some examples, the control plane 202 is set with more than one API server(s) 212 to balance the traffic of information exchanged between the nodes 204 and the control plane 202. The scheduler(s) 214 monitor the nodes 204 and execute scheduling processes to the nodes 204. For example, the scheduler(s) 214 monitors events related to newly created pods and selects one of the nodes 204 for execution, if the newly created pods are not assigned to any of the nodes 204 in the cluster.

The cluster data store 216 is configured to operate as the central database of the cluster. In this example, resources of the cluster and/or definition of the resources (e.g., the required state and the actual state of the resources) can be stored in the cluster data store 216. The controller manager 210 of the control plane 202 communicates with the nodes 204 through the API server(s) 212 and is configured to execute controller processes. The controller processes can include a collection of controllers and each controller is responsible for managing at least some or all of the nodes 204. The management can include, but is not limited to, noticing and responding to nodes when an event occurs, and monitoring the resources of each node (and the containers in each node). In some examples, the controller in the controller manager 210 monitors resources stored in the cluster data store 216 based on definitions of the resource. As introduced above, the controllers also verify whether the actual state of each resource matches the required state. The controller is able to modify or adjust the resources to mitigate under- and over-provisioning of resources.

In some examples, the controllers in the controller manager 210 should be logically independent of each other and be executed separately. In some examples, the controller processes are all compiled into one single binary that is executed in a single process to reduce system complexity. It is noted the control plane 202 can be run/executed on any machine in the cluster. In some examples, the control plane 202 is run on a single physical worker machine that does not host any pods in the cluster.

In the example of FIG. 2, each node 204 includes an agent 220 and a proxy 222. The agent 220 is configured to ensure that the containers are appropriately executing within the pod of each node 204. The agent 220 is referred to as a kubelet in Kubernetes. The proxy 222 of each node 204 is a network proxy that maintains network rules on nodes 204. The network rules enable network communication to the pods in the nodes 204 from network sessions inside or outside of the cluster. The proxy 222 is a kube-proxy in Kubernetes.

In some examples, each node 204 can be provisioned for a respective tenant. For example, an application (e.g., AI-based application) executed in the cluster of the cloud computing environment can be provisioned for multiple tenants (e.g., each tenant being an enterprise, each enterprise having one or more users that interact with the application). In some examples, a first set of the nodes 204 can be provisioned for a first tenant and a second set of the nodes 204 can be provisioned for a second tenant.

In some examples, each node 204 can be described as a compute instance that provides computing resources (e.g., processors, memory) for executing the application. In some examples, each node 204 can be of a respective type in a set of types, and each type can be described as representing a resource plan. Resource plans each provide a configuration of CPU cores, GPU cores, and memory, for a respective compute instance. In the example context of SAP AI Core, example resource plans can include, without limitation, Basic, Basic-8x, Starter, Infer-S, Infer-M, Infer-L and Train-L. Table 1 provides a summary of example resource plans:

TABLE 1
Example Resource Plans

| Resource Plan | GPUs | CPUs | Memory (GB) |
|---|---|---|---|
| Train-L | 1 V100 | 7 | 55 |
| Infer-S | 1 T4 | 3 | 10 |
| Infer-M | 1 T4 | 7 | 26 |
| Infer-L | 1 T4 | 15 | 58 |
| Starter | — | 1 | 3 |
| Basic | — | 3 | 11 |
| Basic-8x | — | 31 | 116 |

As described in further detail herein, the CI predictor of the present disclosure predicts a number of compute instances and types thereof that are to be provisioned for a time period. In some instances, cloud applications can run on a hyperscaler runtime environment (e.g., provided by a third-party), where the hyperscaler can manage adjustment of compute instances for each time period based on the respective prediction.

In further detail, for each tenant, historic compute instance (CI) data is collected that is representative of compute instances that the tenant consumed over one or more past time periods (e.g., hours, days, weeks). In some examples, the historic CI data is specific to an application previously executed on the compute instances. In some examples, the historic CI data is provided by a statistics collector that monitors compute instances instantiated for each tenant and collects data representative thereof. Table 2 depicts example historic CI data that can be collected in the example context of SAP AI Core:

TABLE 2
Example Historic CI Data

| No. | Data Field | Data Type |
|---|---|---|
| 1 | TenantID | Alpha Numeric |
| 2 | AIModelID/DeploymentId | Alpha Numeric |
| 3 | ResourcePlan | Basic, Basic-8x Starter, |
| | | Infer-S, etc. |
| 4 | Replicas | Number |
| 5 | AvgCPUUtilization | Number |
| 6 | TotalRPM | Number |
| 7 | Hyperscaler | AWS, Azure, GCP |
| 8 | Region | US-east-1, EU-central-1, etc. |
| 9 | Availability Zone | US-east-1a, US-east-1b, etc. |
| 10 | Timestamp | Timestamp |

In the example of Table 2, the TenantID uniquely identifies a tenant and the AIModelID uniquely identifies an AI model that is executed by the compute instances. Consequently, historic CI data collected in accordance with the example of Table 2 is specific to a tenant and an AI model. For each tenant, the historic CI data is stored in a data store and is used to train a CI predictor for the respective tenant.

In some implementations, the historic CI data is pre-processed to provide historic CI training data that is used to train the CI predictor. In some examples, a data pre-processor reads the historic CI data stored in the data store and processes it so that it can be used to train the CI predictor. In some examples, pre-processing can include replacing any missing values by appropriate values. For example, if an integer value is missing, an average, minimum, or maximum value from the same field can be used to replace it. In some examples, pre-processing can include removing invalid values. For example, any garbage, null or missing numeric or string that does not have any business significance can be considered as invalid and can be removed. Any appropriate data pre-processing techniques can be used to provide the historic CI training data from the historic CI data.

In some implementations, the data pre-processor adds one or more fields to the historic IC data to provide the historic IC training data. Table 3 depicts example fields that can be added:

TABLE 3
Example Fields to Add

| No. | Field | Datatype | Comment |
|---|---|---|---|
| 1 | holiday | boolean | True if holiday |
| 2 | weekend | boolean | True if holiday |
| 3 | isSpecialDate | boolean | If there is any marketing campaign |
| | | | being run, auspicious or religiously |
| | | | important day, etc. |
| 4 | Time of Day | string | 6 AM~12 noon: Morning |
| | | | 12 noon~7 PM: Afternoon |
| | | | 7 PM~2 AM: Evening |
| | | | 2 AM~6 AM: Night |

As introduced above, the CI predictor is trained using the historic IC training data. The CI predictor can be provided as any appropriate ML model. Example ML models include, without limitation, a linear regression model, a random forest model, a recurrent neural network (RNN), and a convolution neural network (CNN). In a non-limiting example, the CI predictor is provided as a linear regression model that is trained using the historic IC training data.

In general, the CI predictor, as a ML model, can be iteratively trained, where, during an iteration, one or more parameters of the ML model are adjusted, and an output is generated based on the training data. For each iteration, a loss value is determined based on a loss function. The loss value represents a degree of accuracy of the output of the ML model. The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration of training. In some instances, this process is repeated until the loss value meets the expected value.

In some implementations, the CI predictor includes a restful (REST) application programming interface (API) wrapper to expose endpoints for accessing the CI predictor. That is, for example, a POST API endpoint is exposed to receive requests for a prediction of CI instances for a time period. In some examples, a request includes a set of input parameters that are processed by the CI predictor to provide a prediction as output. Table 4 depicts example input parameters that can be included in requests:

TABLE 4
Example Input Parameters

| No. | Data Field | Datatype |
|---|---|---|
| 1 | Replicas | Integer |
| 2 | Avg CPU utilization | number |
| 3 | Total RPM | number |
| 4 | Hyperscaler | AWS, Azure, GCP |
| 5 | Region | US-east-1, EU-central-1, etc. |
| 6 | Availability Zone | US-east-la, US-east-1b, etc. |
| 7 | Holiday | boolean |
| 8 | Weekend | boolean |
| 9 | isSpecialDate | boolean |
| 10 | Time of Day | string |

In the example of Table 4, replicas specifies the current replica count, which the CI predictor can take into account in predicting for the next time period. The CI predictor processes the input parameters to provide a prediction that includes a type (resource plan) of compute instance (node) and, for each, a number of compute instances. Listing 1 provides an example output of the CI predictor that is returned through the API:

```
{
warmNodes: [
    {
    “resourceGroup”: “basic”,
    “nodes”: 2
    },
    {
    “resourceGroup”: “basic.8x”,
    “nodes”: 1
    },
    {
    “resourceGroup”: “infer.s”,
    “nodes”: 0
    },
    {
    “resourceGroup”: “infer.m”,
    “nodes”: 0
    },
    {
    “resourceGroup”: “infer.l”,
    “nodes”: 3
    }
  ]
}
```

### Listing 1: Example API Output

In some implementations, a compute instance (CI) adjuster submits the request for the prediction, receives the prediction, and initiates adjustment of the compute instances based on the prediction. In some examples, the CI adjuster is provided as a CronJob in Kubernetes. A CronJob can be described as creating Kubernetes jobs on a repeating schedule enabling regular tasks to be automated. In the context of the present disclosure, requests for predictions can be a regularly scheduled task. For example, during a current time period, a prediction can be requested for a next time period to adjust a number and types of compute instances from a current configuration (executing for the current time period) to another configuration (to be executed for the next time period).

In some implementations, the CI adjuster will call the POST/predict API endpoint exposed by the CI predictor to get the predictions for nodes to be reserved in advance for each tenant. That is, a request is sent for each tenant. After receiving the predictions from CI predictor, CI adjuster calls a runtime adapter PATCH/resource/nodes API to adjust the reserved nodes inside the cluster for each tenant. In some examples, PATCH/resource/nodes is used to configure (create/update/delete) reserve nodes in the cluster for a given tenant. Listing 2 provides an example input to the runtime adapter API:

```
{
  “resourcePlans”:[
    {
      “name”:“basic”,
      “request”:1
    },
    {
      “name”:“infer.l”,
      “request”:2
    },
    {
      “name”:“infer.m”,
      “request”:3
    },
    {
      “name”:“train.l”,
      “request”:2
    }
  ]
}
```

### Listing 2: Example Input to Runtime Adapter API

In response, the requested compute instances are reserved and a confirmation is returned from the runtime adapter API.

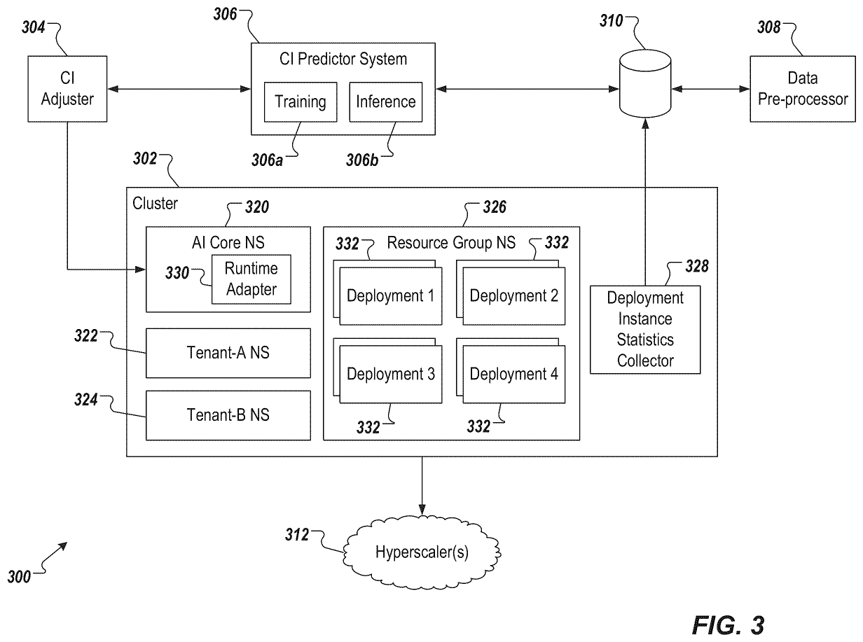

FIG. 3 depicts a conceptual architecture 300 in accordance with implementations of the present disclosure. The example of FIG. 3 is based on the non-limiting example of SAP AI Core. In the example of FIG. 3, the conceptual architecture 300 includes a cluster 302, a CI adjuster 304, a CI predictor system 306, a data pre-processor 308, a data store 310, and one or more hyperscalers 312. The CI predictor system 306 includes a training sub-system 306a and an inference sub-system 306b. As described in detail herein, the training sub-system 306a trains one or more CI predictors and the inference sub-system 306b executes the (trained) CI predictor(s) to provide predictions. In some examples, each CI predictor is specific to a tenant based on historical CI training data for the respective tenant. In some examples, a CI predictor (tenant agnostic) can be used to predict the CI instances for all tenants.

In the example of FIG. 3, the cluster 302 includes an AI core namespace (NS) 320, a first tenant NS 322, a second tenant NS 324, a resource group NS 326, and a deployment instance statistics collector 328. The AI core NS 320 includes a runtime adapter 330 and the resource group NS 326 includes deployments 332. In some examples, each deployment 326 includes resources and workloads for a respective tenant, which are isolated from all other tenants. More particularly, a deployment 332 represents a virtual collection of related resources within the scope of one tenant and is created when the tenant is onboarded.

In some implementations, the first tenant NS 322 includes compute instances (nodes) that are instantiated for a first tenant, and the second tenant NS 324 includes compute instances (nodes) that are instantiated for a second tenant. Each compute instance is of a respective type (e.g., Basic, Basic-8x, Starter, Train-L, Infer-S, Infer-M, Infer-L) and multiple compute instances can be provided for each type.

In some implementations, the deployment instance statistics collector 328 collects historical CI data for each tenant (e.g., indexed based on TenantID). In some examples, the historical CI data is also indexed based on the ML model (e.g., based on AImodelID) that is executed on one or more nodes of the respective tenant. The historical CI data is stored in the data store 310. In some examples, the data pre-processor 308 retrieves historical CI data from the data store 310 and pre-processes the historical CI data to provide historical CI training data, as described herein. Although the data pre-processor 308 is depicted as a separate entity, it is contemplated that the data pre-processor 308 can be included as part of the CI predictor system 306.

In some implementations, for each tenant, the training sub-system 306a retrieves historical CI training data and trains a CI predictor based on the historical CI training data, as described herein. The (trained) CI predictor is executed by the inference sub-system 306b to provide a prediction, as described herein. For example, the CI adjuster 304 (e.g., Kubernetes CronJob) can provide a request for a prediction for a respective tenant to the CI predictor system 306 through an API (not shown) and the CI predictor system 306 returns a prediction. In response to the prediction, the CI adjuster 304 sends a request to the runtime adapter 330 through an API (not shown) to request instantiation of compute instances for the respective tenant. In some examples, the runtime adapter 330 coordinates instantiation of the compute instances with a hyperscaler 312. In some examples, after receiving a reserve nodes API request from the CI adjuster 304, if the requested nodes are present in the cluster 302 then runtime adapter 330 will reserve these nodes for the tenant. If required nodes are not present in the cluster 302 then cluster will request to hyperscaler to provision the requested nodes.

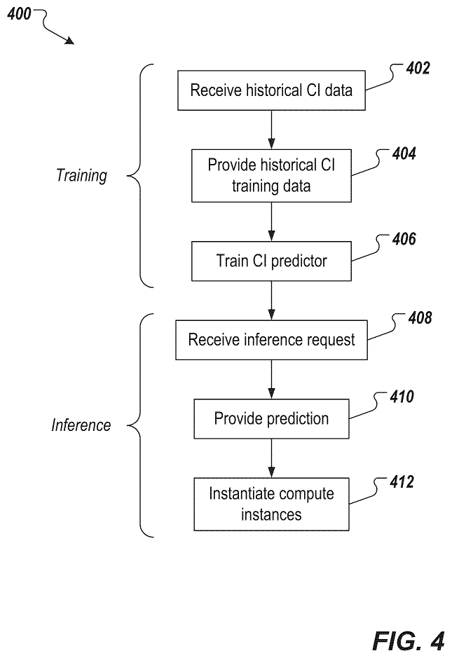

FIG. 4 depicts an example process 400 that can be executed in accordance with implementations of the present disclosure. In some examples, the example process 400 is provided using one or more computer-executable programs executed by one or more computing devices. In some examples, the example process 400 can be executed for each tenant of a set of tenants that consume compute instances within a cloud computing environment.

Historical CI data is received (402). For example, and as described in further detail herein, the deployment instance statistics collector 328 of FIG. 3 collects historical CI data for each tenant (e.g., indexed based on TenantID). In some examples, the historical CI data is also indexed based on the ML model (e.g., based on AImodelID (deploymentID)) that is executed on one or more nodes of the respective tenant. The historical CI data is stored in the data store 310. Historical CI training data is provided (404). For example, and as described in further detail herein, the data pre-processor 308 retrieves historical CI data from the data store 310 and pre-processes the historical CI data to provide historical CI training data. A CI predictor is trained (406). For example, and as described in further detail herein, for each tenant (e.g., and each AI model), the training sub-system 306a retrieves historical CI training data and trains a CI predictor based on the historical CI training data.

An inference request is received (408) and a prediction is provided (410). For example, and as described in further detail herein, the CI adjuster 304 (e.g., Kubernetes CronJob) can provide a request for a prediction for a respective tenant to the CI predictor system 306 through an API and the CI predictor system 306 returns a prediction. Compute instances are instantiated (412). For example, and as described in further detail herein, the CI adjuster 304 sends a request to the runtime adapter 330 through an API (not shown) to request instantiation of compute instances for the respective tenant.

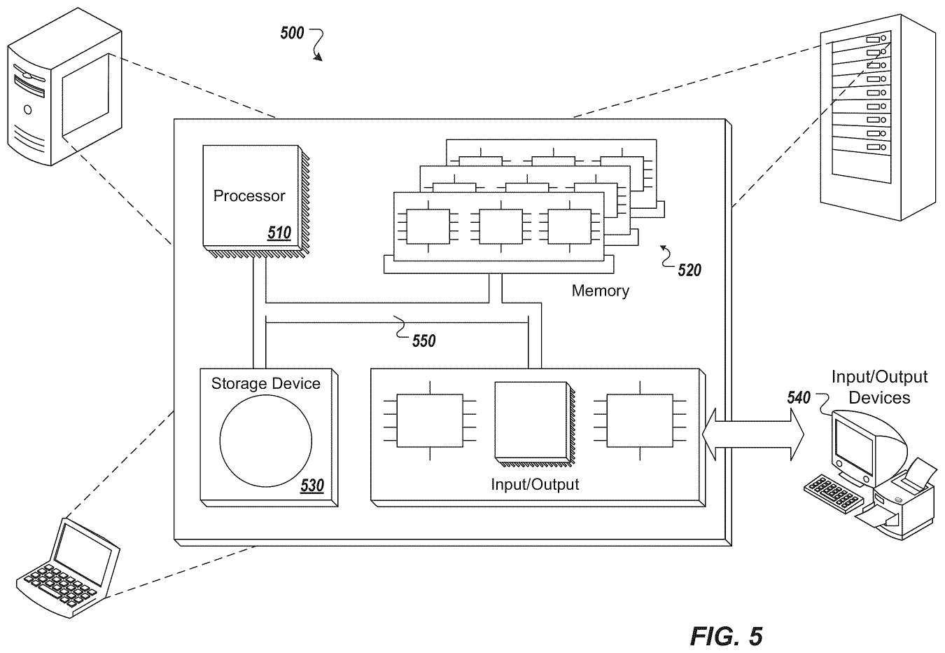

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for reserving compute instances in cloud computing environments, the method being executed by one or more processors and comprising:
providing historic compute instance (CI) training data at least partially representative of one or more compute instances executing an application in a cloud computing environment, the one or more compute instances being provided in a tenant namespace for a tenant, the tenant namespace being provided in a cluster of the cloud computing environment;
training a CI predictor using the historic CI training data;
receiving, from a CI adjuster, a first prediction request;
transmitting, in response to the first prediction request, a first prediction generated by the CI predictor based on the first prediction request; and
instantiating a first set of compute instances within the tenant namespace in response to the first prediction.

2. The method of claim 1, wherein the first prediction defines the first set of compute instances and, for each compute instance in the first set of compute instances, assigns a type.

3. The method of claim 2, wherein each type corresponds to a release plan in a set of release plans, each release plan defining a number of processors and a memory size for a respective compute instance.

4. The method of claim 1, wherein the CI predictor is specific to the tenant and the application.

5. The method of claim 1, wherein the first set of compute instances is instantiated for a time period.

6. The method of claim 1, further comprising:
receiving, from the CI adjuster, a second prediction request;
transmitting, in response to the second prediction request, a second prediction generated by the CI predictor based on the second prediction request; and
instantiating a second set of compute instances within the tenant namespace in response to the second prediction, the second set of compute instance being instantiated for a time period after the first set of compute instances.

7. The method of claim 1, wherein the CI predictor is provided as a linear regression model.

8. A non-transitory computer-readable storage medium coupled to one or more processors and having instructions stored thereon which, when executed by the one or more processors, cause the one or more processors to perform operations for reserving compute instances in cloud computing environments, the operations comprising:
providing historic compute instance (CI) training data at least partially representative of one or more compute instances executing an application in a cloud computing environment, the one or more compute instances being provided in a tenant namespace for a tenant, the tenant namespace being provided in a cluster of the cloud computing environment;
training a CI predictor using the historic CI training data;
receiving, from a CI adjuster, a first prediction request;
transmitting, in response to the first prediction request, a first prediction generated by the CI predictor based on the first prediction request; and
instantiating a first set of compute instances within the tenant namespace in response to the first prediction.

9. The non-transitory computer-readable storage medium of claim 8, wherein the first prediction defines the first set of compute instances and, for each compute instance in the first set of compute instances, assigns a type.

10. The non-transitory computer-readable storage medium of claim 9, wherein each type corresponds to a release plan in a set of release plans, each release plan defining a number of processors and a memory size for a respective compute instance.

11. The non-transitory computer-readable storage medium of claim 8, wherein the CI predictor is specific to the tenant and the application.

12. The non-transitory computer-readable storage medium of claim 8, wherein the first set of compute instances is instantiated for a time period.

13. The non-transitory computer-readable storage medium of claim 8, wherein operations further comprise:
receiving, from the CI adjuster, a second prediction request;
transmitting, in response to the second prediction request, a second prediction generated by the CI predictor based on the second prediction request; and
instantiating a second set of compute instances within the tenant namespace in response to the second prediction, the second set of compute instance being instantiated for a time period after the first set of compute instances.

14. The non-transitory computer-readable storage medium of claim 8, wherein the CI predictor is provided as a linear regression model.

15. A system, comprising:
a computing device; and
a computer-readable storage device coupled to the computing device and having instructions stored thereon which, when executed by the computing device, cause the computing device to perform operations for reserving compute instances in cloud computing environments, the operations comprising:
providing historic compute instance (CI) training data at least partially representative of one or more compute instances executing an application in a cloud computing environment, the one or more compute instances being provided in a tenant namespace for a tenant, the tenant namespace being provided in a cluster of the cloud computing environment;
training a CI predictor using the historic CI training data;
receiving, from a CI adjuster, a first prediction request;
transmitting, in response to the first prediction request, a first prediction generated by the CI predictor based on the first prediction request; and
instantiating a first set of compute instances within the tenant namespace in response to the first prediction.

16. The system of claim 15, wherein the first prediction defines the first set of compute instances and, for each compute instance in the first set of compute instances, assigns a type.

17. The system of claim 16, wherein each type corresponds to a release plan in a set of release plans, each release plan defining a number of processors and a memory size for a respective compute instance.

18. The system of claim 15, wherein the CI predictor is specific to the tenant and the application.

19. The system of claim 15, wherein the first set of compute instances is instantiated for a time period.

20. The system of claim 15, wherein operations further comprise:
receiving, from the CI adjuster, a second prediction request;
transmitting, in response to the second prediction request, a second prediction generated by the CI predictor based on the second prediction request; and
instantiating a second set of compute instances within the tenant namespace in response to the second prediction, the second set of compute instance being instantiated for a time period after the first set of compute instances.
